(19) United States
(12) Patent Application Publication
(10) Pub. No.: US 2017/0201782 A1
(43) Pub. Date: Jul. 13, 2017

(54) DEVICES, SYSTEMS, AND METHODS FOR RETRIEVING AND DISTRIBUTING REMOTE VIDEO SNAPSHOTS

(71) Applicant: Live View Technologies, Orem, UT (US)

(72) Inventors: Steven Richard Lindsey, Lehi, UT (US); Skyler J. Call, Lehi, UT (US)

(21) Appl. No.: 14/990,588

(22) Filed: Jan. 7, 2016

(51) Int. Cl. H04N 21/262; H04N 7/18; H04N 21/234; G06K 9/62; H04N 21/458; H04N 21/435; H04L 29/08; H04N 5/44

(52) U.S. Cl. CPC H04N 21/262; H04L 67/06; H04L 67/10; H04L 67/02; H04N 7/183; H04N 5/44; G06K 9/6215; H04N 21/458; H04N 21/435; H04N 21/23424

(57) ABSTRACT

The present invention is directed to a camera system and method. The system and method include at least one camera configured to operate over a network, and a server coupled to the at least one camera over the network. The server captures an image from the at least one camera according to a schedule identifying at least one change in setting to the at least one camera. The server then processes the image according to an image processing parameter to generate a processed image. The server further distributes the processed image according to a distribution list of destinations in the schedule.

### TECHNICAL FIELD

This disclosure relates generally to camera systems and, more specifically, to methods, devices, and systems for retrieving and distributing remote video snapshots.

### BACKGROUND OF RELATED ART

Conventional video surveillance systems are on-premise, vender-specific, and utilize localized digital video recorders (DVR) and/or network video recorders (NVR) with limited accessibility outside of the area in which they are positioned. As digital technology has advanced and Internet protocol (IP) cameras have become widely available, the implementation of these IP-enabled cameras into video surveillance systems has not changed. Camera systems are being implemented at an increasing rate across broad geographical areas, and the need to centralize management as well as to provide secure global access to these disparate camera systems is becoming a critical necessity.

The increased data capabilities of cellular and satellite providers make it possible to place cameras virtually anywhere in the world. Typically, cameras provide a way for a user to manually download a single image to their local computer storage or to configure it to upload an image to a single FTP server only. However, there is a need to regularly capture still shots/images from the cameras, supplement the images and distribute the images for access by users of the system.

### BRIEF SUMMARY OF THE INVENTION

In one specific embodiment, a system may include at least one camera configured to operate over a network, and a server coupled to the at least one camera over the network. The server is configured to capture an image from the at least one camera according to a schedule identifying at least one change in setting to the at least one camera. The server is further configured to process the image according to an image processing parameter to generate a processed image. The server is then configured to distribute the processed image according to a distribution list of destinations in the schedule.

In another specific embodiment, a method may include capturing an image from at least one camera configured to operate over a network according to a schedule identifying at least one change in setting to the at least one camera. The method further includes processing the image according to an image processing parameter to generate a processed image at a server coupled over the network to the at least one camera. The method additionally includes distributing over the network the processed image according to a distribution list of destinations in the schedule.

### BRIEF DESCRIPTION OF THE DRAWINGS

FIG. 1 illustrates a cloud-based camera system.

FIG. 2 depicts a system, according to an embodiment of the present disclosure.

FIG. 3 is a block diagram of a system for implementing various embodiments of the present disclosure.

FIG. 4 is a flowchart illustrating a method, according to an embodiment of the present disclosure.

FIG. 5 is a flowchart of another method, in accordance with an embodiment of the present disclosure.

FIG. 6 is a flowchart of another method, in accordance with an embodiment of the present disclosure

### DETAILED DESCRIPTION

Referring in general to the accompanying drawings, various embodiments of the present invention are illustrated to show the structure and methods for recording and retrieving video with a system, such as a video surveillance system. Common elements of the illustrated embodiments are designated with like numerals. It should be understood that the figures presented are not meant to be illustrative of actual views of any particular portion of the actual device structure, but are merely schematic representations which are employed to more clearly and fully depict embodiments of the invention.

The following provides a more detailed description of the present invention and various representative embodiments thereof. In this description, functions may be shown in block diagram form in order not to obscure the present invention in unnecessary detail. Additionally, block definitions and partitioning of logic between various blocks is exemplary of a specific implementation. It will be readily apparent to one of ordinary skill in the art that the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

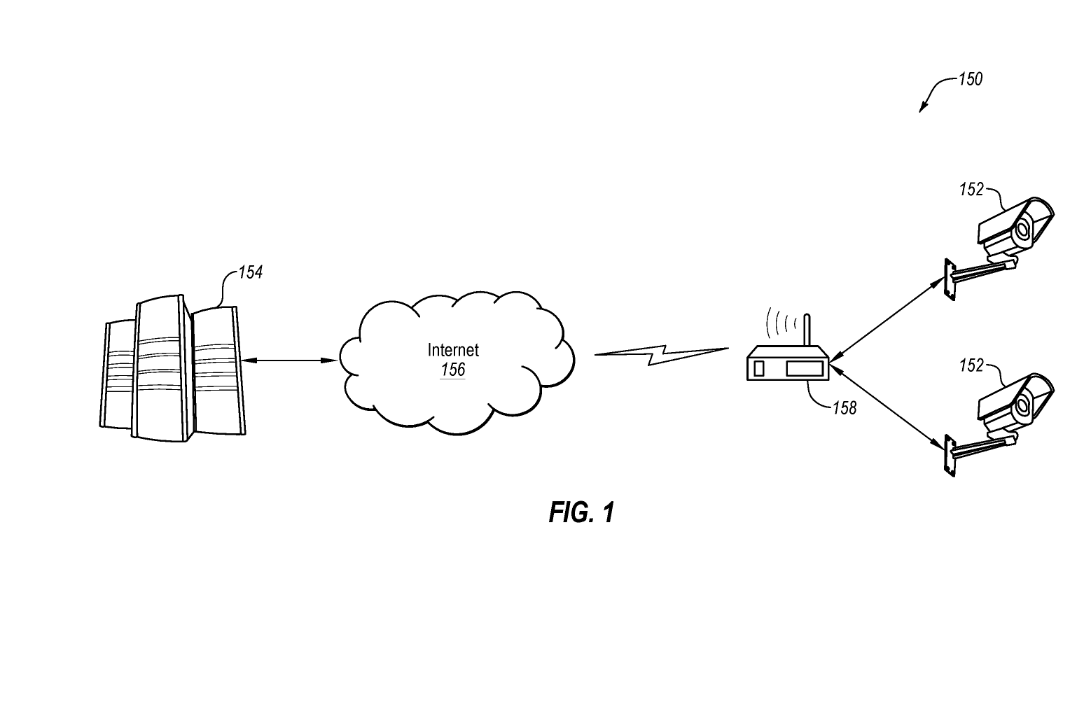

FIG. 1 depicts a cloud-based camera system 150 including one or more cameras 152 coupled to one or more servers 154 via the Internet 156 and a modem 158 (i.e., a cellular or satellite modem). Some disadvantages of cloud-based camera systems are poor video quality and expensive monthly communication costs. A cloud-based camera system may require one or more cameras at a remote location to continuously stream video over a metered Internet connection (i.e., 24 hours a day/7 days a week). This constant streaming of video over an Internet connection is very expensive. Furthermore, images that are captured by one or more cameras 152 may require additional processing and distribution.

Exemplary embodiments, as described herein, relate to a camera system configured to provide an automated and scalable solution for retrieving live pictures from a large number of cameras of varying model, perform end-user defined post processing on the image, and distribute the image to one or many end-user defined destination servers using various protocols. Typically, cameras provide a way for a user to manually download a single image to their local computer storage or to configure the camera to upload an image to a single FTP server only. The exemplary embodiments provide an Internet cloud solution for an image downloaded from various cameras, allow post-capture processing of the image, and simplify the distribution of the image to one or many servers. The system and method allows a user to have a single place to configure how often the image is downloaded, the quality of image downloaded, the modifications made to the image after downloading, and which destinations should receive the image through distribution.

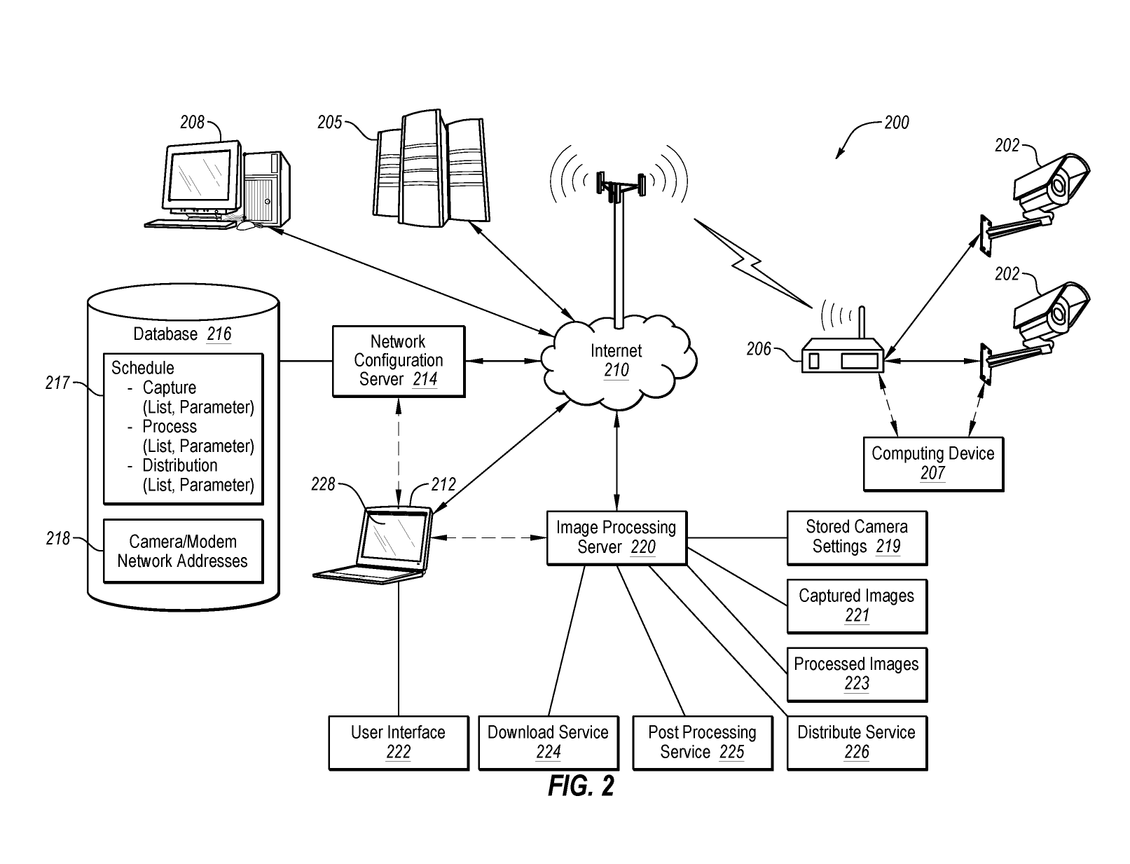

FIG. 2 depicts a system 200 in accordance with an embodiment of the present disclosure. System 200, which may also be referred to as a “video camera system,” includes one or more cameras 202. System 200 may further include one or more electronic devices 208, which may comprise, for example only, a mobile device (e.g., mobile phone, tablet, etc.), a desktop computer, or any other suitable electronic device including a display. Electronic device 208 may be accessible to one or more end-users. A modem 206, which may comprise any suitable and known modem, may be coupled to cameras 202, via wired connections, wireless connections, or a combination thereof. Modem 206 may further be coupled to electronic devices 208 via the Internet 210. System 200 may further include a server 205 (e.g., a cloud server), which is remote from cameras 202 and which is communicatively coupled to each electronic device 208 and each modem 206. According to various embodiments of the present disclosure, camera 202, and modem 206 may be within a first location (a “camera location”), and server 205 may be within a second location, remote from the camera location. In addition, each electronic device 208 may be remote from the camera location and server 205. As will be appreciated by a person having ordinary skill in the art, system 200 is modular, expandable, and scalable.

Cameras 202 may each be connected to modem 206 through wireless bridges and wireless access points (not shown) where each node may have one of a public or private network address. Attempts to connect to either the various nodes including cameras 202 utilizes specific public IP addresses and service ports, and private IP using network topologies such as VPN (Virtual Private Network), DVN (Dispersive Virtual Network), VPC (Virtual Private Cloud), etc. By way of example, complex mapping of network associations is performed by a network manager 212 accessing a network configuration server 214 which then stores network mapping data in a database 216. Database 216 further includes a schedule 217 which may include various lists and parameters. By way of example, schedule 217 includes a capture list and parameter data identifying camera identifiers, scheduling timelines, default, current and specific camera settings including pan, tilt, zoom (PTZ), focus settings, I/O settings (e.g., lights on/off), and a corresponding cross-reference to proprietary commands to cause specific ones of cameras 202 to perform the various functions.

Schedule 217 further includes a process list and parameter data identifying specific selectable processes to be performed on a captured image. By way of example and not limitation, image processes may include image overlays including watermarks, time stamps, camera settings for the specific image, and other information that may be useful to a viewer of the captured image.

Schedule 217 may yet further include a distribution list and parameter data identifying various server and delivery protocols. The distribution list and parameter data identify which servers or destinations should receive the captured and processed images. The parameter data may further identify distribution file transfers (e.g., SCP, FTP, HTTP, etc.) to support the transfer of the processed images. Furthermore, schedule 217 may also include which processing server (e.g., 220) should perform the work of camera settings 219, captured images 221, processed images 223, download service 224, post processing service 225, and distribute service 226. Work can be distributed across various other servers configured to perform operations such as those of server 220.

System 200 may further include an image processing server 220, which may support a user interface 222 presented on, for example, a browser 228 of network manager 212. Image processing server 220 may further include a download service 224, a post processing service 225, and a distribute service 226.

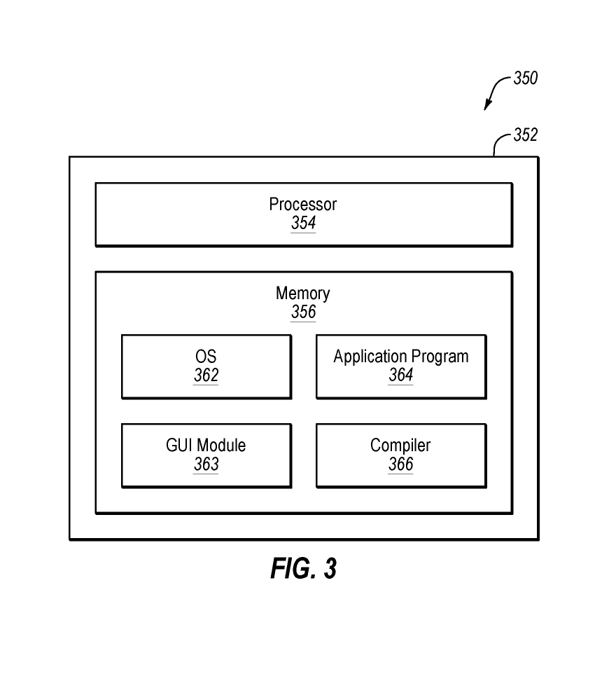

FIG. 3 illustrates a system 350 that may be used to implement embodiments of the present disclosure. System 350 may include a computer 352 that comprises a processor 354 and memory 356. For example only, and not by way of limitation, computer 352 may comprise a workstation, a laptop, or a hand held device such as a cell phone or a personal digital assistant (PDA), a server (e.g., server 205) or any other processor-based device known in the art. In one embodiment, computer 352 may be operably coupled to a display (not shown in FIG. 3), which presents images to the user via a GUI.

Generally, computer 352 may operate under control of an operating system 362 stored in the memory 356, and interface with a user to accept inputs and commands and to present outputs through a GUI module 363. Although GUI module 363 is depicted as a separate module, the instructions performing the GUI functions may be resident or distributed in the operating system 362, an application program 364, or implemented with special purpose memory and processors. Computer 352 may also implement a compiler 366 that allows application program 364 written in a programming language to be translated into processor 354 readable code. After completion, application program 364 may access and manipulate data stored in the memory 356 of the computer 352 using the relationships and logic that are generated using the compiler 366.

Further, operating system 362 and application program 364 may include instructions that, when read and executed by the computer 352, may cause the computer 352 to perform the steps necessary to implement and/or use embodiments of the present invention. Application program 364 and/or operating instructions may also be tangibly embodied in memory 356 and/or data communications devices, thereby making a computer program product or article of manufacture according to an embodiment the invention. As such, the term “application program” as used herein is intended to encompass a computer program accessible from any computer readable device or media. Application program 364 may exist on an electronic device (e.g., electronic device 208 network manager 212; see FIG. 2) or a server (e.g., server 220, 214 and 205; see FIG. 2). Furthermore, portions of application program 364 may be distributed such that some of application program 364 may be included on a computer readable media within an electronic device (e.g., electronic device 208) and some of application program 364 may be included on a server (e.g., server 205). In other embodiments, application program 364 may be configured to run on computing device 207, electronic device 208, network manager 212, servers 214, 220, modem 206, or any combination thereof. As a specific example, application program may exist on servers 205, 220, 214 and may be accessible to an end-user via an electronic device 208 or a network manager 212.

With reference to FIGS. 1-3, a contemplated operation of system 200 will now be described. During operation, system 200 captures and collects (called “patrol”), processes, and distributes camera snapshots from a large number of cameras 202 to any number of destinations. The method accommodates various camera manufacturers, models, and types (i.e., fixed, Pan-Tilt-Zoom (PTZ), etc). The method provides many advantages and improvements by managing, through manipulation and restoration, the camera settings, and provides self-service by end-users including manual “patrol” resume/suspension, control of any supplemental lighting, customizable post-processing of image, and distribution to one or many servers defined by end-user over any protocol.

System 200 provides a way to apply camera settings (i.e., display date/time overlays, move Pan-Tilt-Zoom (PTZ) camera to a specific user-defined location/field of view, turning on any supplemental lighting, etc.) prior to taking a picture as well as restoring the camera's settings back when finished. This allows a picture or multiple pictures to be taken of various fields of view with attached lighting devices enabled/disabled as well as any time/date or other text or graphic overlays to be applied at the time the picture is taken. After the picture(s) are taken, the camera settings can be restored to the state they were in prior to pre-picture changes being made. This feature is especially useful with Pan-Tilt-Zoom (PTZ) capable cameras. The end-user has full control of the schedule and frequency as well as the field of view in which the pictures are taken.

Further, system 200 allows the end-user to manually suspend or resume picture taking (called “patrol”) using the user interface. This unique feature allows the end-user to either not be interrupted by “patrols” while watching a live camera stream or allows for privacy when needed. In either case, the “patrol” will automatically resume after a predetermined period of time ensuring pictures are taken if the end-user forgets to resume “patrol”.

After “patrol” is complete and images from a camera(s) are collected, the present embodiment can perform image post processing where end-user defined manipulation of the images can be performed. Post processing includes but is not limited to resizing, converting to other format(s), text or graphic overlays/watermarking, seaming, motion detection, time-lapse generation, recognition/analysis, etc.

Additionally, system 200 is capable of distributing images to various servers via various protocols (i.e., SCP, FTP, HTTP, etc.) as defined by the end-user. An end-user may have a need to distribute an image to multiple servers in a load-balanced configuration for public viewing or backup purposes. End-users may utilize differing file transfer protocols making it necessary to be flexible in how images are distributed.

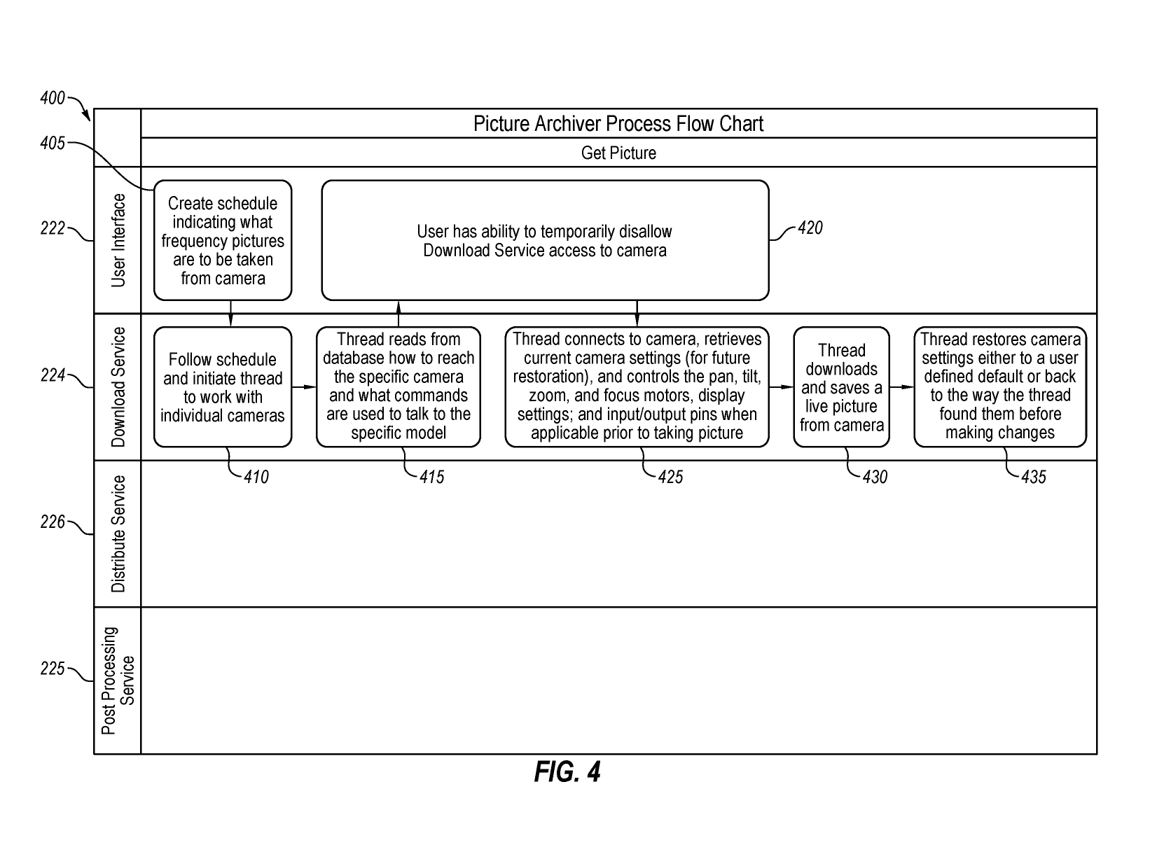

FIG. 4 is a flowchart 400 illustrating a method for obtaining images from a camera, in accordance with an embodiment of the present disclosure. With reference to FIGS. 1-3, method 400 will now be described. Initially, a user or a network manager through a user interface 222 (FIG. 2) on or accessed through a network manager 212 or user device 208 may create or select a schedule including a date, and alternatively, a time range (depicted by act 405) resulting in a schedule indicating the frequency at which pictures are to be taken from a camera. A user creates a schedule 217 for an individual camera or group of camera designating the frequency images are captured. This schedule is flexible enough that the frequency can change at any time throughout the day and week.

Download service 224 then follows the schedule and initiates a thread to work with individual cameras in a step 410. A download service thread is started and works with an individual camera or group of cameras based on the set schedule. Each thread is given parameters from database 216 designating instructions for communicating standardized user requests into specific instructions compatible with different models of cameras. The thread also includes network addresses 218 identifying, for example, an IP address of the designated camera or modem with a port forwarding to the camera. Further, the thread also includes the camera settings including any I/O settings (e.g., activation/deactivation of supplemental lighting, etc.) that should be configured prior to capturing the image. Accordingly, download service 224, as depicted in act 415, then through the thread reads the database 216 to determine how to reach the specific camera and what commands are used to talk to the specific model of camera.

Alternatively, user interface 222 responds to a user or network manager to temporarily disallow download service access to the selected camera (depicted by act 420) by overriding the scheduled patrol capturing, processing and distribution of images.

As depicted by act 425, download service 224 via the thread connects to the identified camera and retrieves the current camera settings and stores them as stored camera settings 219, controls the camera including orientation, focus, display and other I/O setting prior to capturing an image from the camera. A download service thread communicates with a camera to manipulate its settings, download a picture, and restore its settings based on the stored camera settings 219. More specifically, download service 224 retrieves and stores the current camera settings as stored camera settings 219 for future restoration of the settings following any customization of settings specified in schedule 217 during capturing of an image. The download service 224 further controls the pan, tilt zoom and focus motors of the selected camera. Additionally, other display settings and I/O pins/controls (e.g., enhanced lighting) associated with the camera may also be controlled prior to capturing an image from the camera. Download service 224 then captures an image from the camera.

As depicted by act 430, download service 224 according to the thread then downloads and saves as captured images 221 an image captured by the camera.

As depicted by act 435, following capture of the image from the camera, the thread according to download service 224 restores the camera settings from stored camera settings 219 as they were discovered prior to preparing to capture the image.

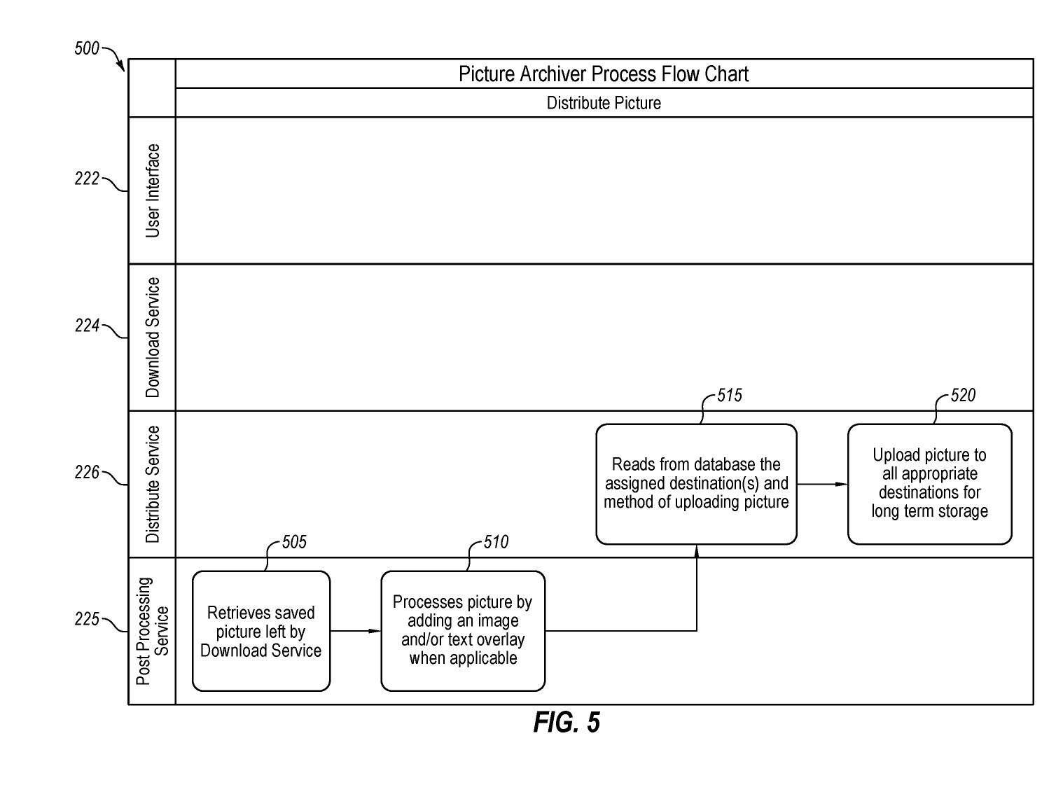

FIG. 5 is a flowchart illustrating a method for distributing images that were previously captured and stored, in accordance with an embodiment of the present disclosure. With reference to FIGS. 1-4, method 500 will now be described. The method 500 retrieves, processes and uploads images previously captured and stored by method 400. Post processing service 225, in an act 505 retrieves a previously saved image from captured images 221. Post processing service 225, depicted by act 510, applies from schedule 217 any post processing such as resizing, format conversion, image/text overlays, and file renaming, and alternatively processes captured images 221 into revised processed images 223 by adding an overlay image including a further image (e.g., watermark) and/or text to the retrieved image. Distribute service 226 then reads from schedule 217, depicted in act 515, to determine the assigned destination and the preferred method of uploading the revised image. Distribute service 226, thereafter in an act 520, uploads the processed images 223 to all of the destinations (e.g., servers 205 of FIG. 2) that were specified by schedule 217 in database 216.

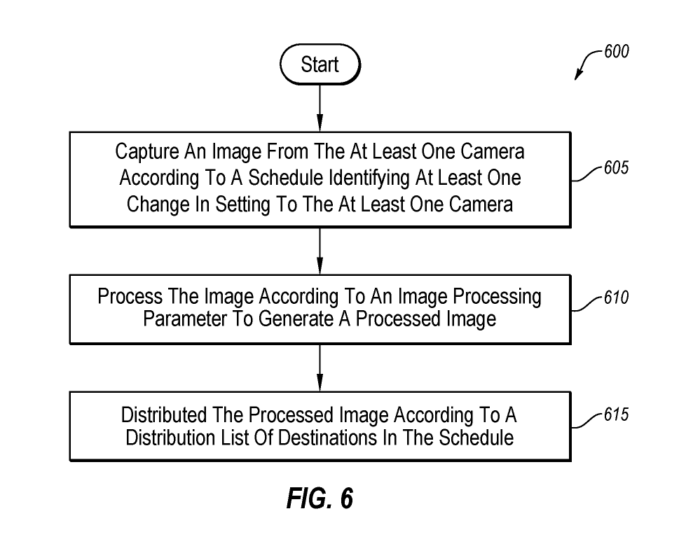

FIG. 6 is a flowchart 600 illustrating a method, in accordance with an embodiment of the present disclosure. With reference to FIGS. 1-5, method 600 will now be described. Initially, a user may configure schedule 217 to include capture, process and distribution lists, parameters and instructions for carrying out the various acts and embodiments described herein. A system includes at least one camera configured to operate over a network. The system further includes a server coupled to the camera over the network where the server is configured to perform various acts.

In an act 605, an image is captured and stored as a captured image. The image is captured by at least one camera according to a schedule identifying at least one change in setting to the camera. As stated, a previous camera configuration may be stored allowing changes in settings to be configured by a user and stored in a schedule that is being executed by the server.

In an act 610, the captured and stored image is processed according to an image processing parameter to generate a processed image. As stated, processing may include adding an overlay image (e.g., watermark) and/or text to the retrieved image.

In an act 615, the processed image is distributed according to a distribution list of destinations in the schedule. The distribution list includes assigned destinations and the preferred method of uploading (e.g., SCP, FTP, HTTP, etc.) the processed image.

As will be appreciated, system 200 is hardware agnostic, and, thus, may be compatible with most, if not all, cameras (e.g. IP cameras and CCTV cameras with encoders), network connectivity solutions (e.g., broadband, cellular, satellite, WiFi, etc.), and network topologies (e.g., public, private, private on VPN, etc.). In addition, embodiments of the present disclosure may utilize industry standard compression and transport technologies to ensure compatibility with current and future camera technologies. Further, because system 200 is hardware agnostic and provides a camera management layer to all cameras system-wide, camera hardware that fails can be easily and quickly replaced with the same camera model or different hardware or manufacturer or model, all the while the end-user has the exact same experience viewing and operating the camera. It is noted that system 200 may be configured to convey data (i.e., from one or more cameras 202) to any suitable device anywhere in the world, regardless of the original camera manufacturers supported specifications. This may provide users with an unprecedented level of access to their cameras regardless of where they are or what device they may be using at the time. Further, because system 200 may be compatible with all known and suitable cameras, an end-user's hardware investments may be protected for an extended period beyond manufacturers support.

Although the various embodiments have been described with reference to camera systems, the present invention is not so limited. Rather, system 200 may include one or more sensors and/or control devices, integrating additional data and control capabilities to camera locations allowing users to get additional information and to control other systems from a single interface.

System 200 may be implemented with industry standard security protocols, and employ measures to ensure secure streaming video portals. By way of example, system 200 may be configured to require user authentication before access is permitted and users may be assigned specific roles (i.e., permissions) within system 200, which allows the user to access and perform specific camera and system operations. User permissions may include functionality relating to viewing camera stream, viewing camera archives, controlling camera presets, controlling camera pan/tilt/zoom/focus features, suspending camera patrol, and managing camera presets. Further, permissions may be granted according to various permission levels. As one example, a user with “administrator user” permissions can create, edit, view, and delete users under their domain. The user can also change user permissions, camera access rights, reset passwords, and access full analytics.

System 200 may provide a user with full administrator capability. Thus, a user may manage who has access to one or more cameras, when they have access, and how they have access, including user roles, camera access rights, and password.

System 200 may further utilize industry standard encryption techniques. For example, user access to system 200 may be performed over HTTPS (256-bit SSL encryption), and industry standard encryption may be used to encrypt video/audio streams between cameras and video transcoders and relay servers. Further, industry standard encryption may be used to encrypt video and audio streams between video transcoders and relay servers and to an end-user. Because system 200 may obfuscate the camera, sensor, and data acquisition hardware from the end-user, “hacking” is virtually eliminated because all network assets can be on private (non-public accessible) networks.

As will be appreciated by a person having ordinary skill in the art, embodiments of the present disclosure may not require any costly hardware onsite, thus decreasing implementation costs and monthly communications costs. Further, power requirements to run a remote camera system off-grid may be decreased. By keeping recording local to a camera, system 200 may record video 24 hours a day/7 days a week at high video quality without using any communication data across the cellular or satellite connection. When an ‘event’ occurs that a user is interested in seeing, the user can use an online service portal to request the retrieval of video within the time frame of interest from the remote camera. In this way, only the video data of interest is transmitted over the cellular or satellite connection. The retrieved video may be at a high quality and the cost of transmitting a clip of video is much lower than streaming 24/7. Power consumption of the remote camera system will be kept at a minimum because only a camera with a memory card (or low power external hard drive) is needed to record the video.

Although the foregoing description contains many specifics, these should not be construed as limiting the scope of the invention or of any of the appended claims, but merely as providing information pertinent to some specific embodiments that may fall within the scopes of the invention and the appended claims. Features from different embodiments may be employed in combination. In addition, other embodiments of the invention may also be devised which lie within the scopes of the invention and the appended claims. The scope of the invention is, therefore, indicated and limited only by the appended claims and their legal equivalents. All additions, deletions and modifications to the invention, as disclosed herein, that fall within the meaning and scopes of the claims are to be embraced by the claims.

1. A system, comprising:
at least one camera configured to operate over a network; and
at least one server coupled to the at least one camera over the network; the at least one server configured to:
retrieve current settings of the at least one camera;
configure the at least one camera according to one or more commands after retrieving the current setting;
capture an image from the at least one camera according to a schedule identifying at least one change in setting to the at least one camera; and
process the image according to an image processing parameter to generate a processed image; and
distribute the processed image according to a distribution list of destinations in the schedule.

2. The system of claim 1, the at least one server further comprising a network configuration server configured to generate the schedule including the at least one change in setting to the at least one camera, the at least one setting including at least one of a pan, tilt, zoom, focus, display settings, and control I/O.

3. The system of claim 2, the network configuration server further configured prior to the capture of the image to generate the commands for the at least one camera corresponding to the at least one setting of the at least one camera in the schedule.

4. (canceled)

5. (canceled)

6. The system of claim 1, the at least one server further configured to restore the current settings to the at least one camera following the capture of the image by the at least one camera using the at least one change setting.

7. The system of claim 1, the at least one server further configured to override the schedule when selected by a user.

8. The system of claim 1, wherein the at least one server configured to process the image is further configured to retrieve the image.

9. The system of claim 1, wherein the at least one server configured to process the image is further configured to add according to the image processing parameter one of an additional image and text overlay to the image to generate the processed image.

10. The system of claim 1, wherein the at least one server configured to distribute the processed image is further configured to distribute the processed image according to one of a plurality of a plurality of delivery protocols.

11. A method, comprising:
retrieving current settings of at least one camera;
configuring the at least one camera according to one or more commands for the at least one camera after retrieving the current setting of the at least one camera;
capturing an image from the at least one camera configured to operate over a network according to a schedule identifying at least one change in setting to the at least one camera;
processing the image according to an image processing parameter to generate a processed image at a server coupled over the network to the at least one camera; and
distributing over the network the processed image according to a distribution list of destinations in the schedule.

12. The method of claim 11, further comprising generating the schedule including the at least one change in setting to the at least one camera, the at least one setting including at least one of a pan, tilt, zoom, focus, display settings, and control I/O.

13. The method of claim 12, further comprising prior to the capturing of the image, generating commands for the at least one camera corresponding to the at least one setting of the at least one camera in the schedule.

14. (canceled)

15. (canceled)

16. The method of claim 11, further comprising restoring the current settings to the at least one camera following the capturing of the image by the at least one camera using the at least one change setting.

17. The method of claim 11, further comprising overriding the schedule when selected by a user.

18. The method of claim 11, wherein the processing the image further comprises adding according to the image processing parameter one of an additional image and text overlay to the image to generate the processed image.

19. The method of claim 11, wherein the distributing further comprises distributing the processed image the processed image according to one of a plurality of a plurality of delivery protocols.

20. A system, comprising:
means for retrieving current settings of at least one camera;
means for configuring the at least one camera according to one or more commands for the at least one camera after retrieving the current settings;
means for capturing an image from the at least one camera configured to operate over a network according to a schedule identifying at least one change in setting to the at least one camera;
means for processing the image according to an image processing parameter to generate a processed image at a server coupled over the network to the at least one camera; and
means for distributing over the network the processed image according to a distribution list of destinations in the schedule.
